(19) United States
(12) Patent Application Publication
(10) Pub. No.: US 2004/0162798 A1
(43) Pub. Date: Aug. 19, 2004

(54) Knowledge information providing apparatus

(76) Inventors: Masayuki Mamoto, Osaka (JP); Takashi Noguchi, Osaka (JP); Nobuyuki Kondou, Osaka (JP); Tatsuyuki Nakagawa, Osaka (JP); Hitoshi Kihara, Osaka (JP)

Correspondence Address: McDermott, Will & Emery, 600 13th Street, N.W., Washington, DC, 20005-3096, US

(21) Appl. No.: 10/648,188

(22) Filed: Aug. 27, 2003

(30) Foreign Application Priority Data
Aug. 28, 2002 (JP) 2002-249441

(51) Int. Cl. G06F 17/00; G06N 5/02

(52) U.S. Cl. 706/50

(57) ABSTRACT

There are provided a user information database storing for each user the current level of skill in work of the user and information related to the history of the work performed by the user, and means for judging, when the predetermined work performed by an arbitrary user is terminated, the level of skill of the user again to update the current level of skill of the user in the user information database on the basis of the complexity of the contents of the work, information related to the evaluation of the results of the work, the number of times of keyword retrieval performed by the user during the work, the current level of skill of the user, and information related to the history of the work performed in the past by the user.

### BACKGROUND OF THE INVENTION

1. Field of the Invention

The present invention relates to a knowledge providing apparatus that is connected to a user terminal through a network, for example, and provides to the user terminal knowledge for supporting predetermined work performed by a user.

2. Description of the Prior Art

When a user is performing work using a user terminal, a particular user support server has been accessed from the user terminal, to acquire knowledge for supporting the work, for example, an electronic manual indicating the procedure for the work, or the like from the user support server, and display the acquired electronic manual on the user terminal.

An example of the user support server is one for displaying an electronic manual dependent on contents corresponding to the level of skill of a user. However, the level of skill of the user has been conventionally judged by the user himself or herself and set.

Further example of the user support server is one for providing the procedure for work, the contents of the work, and know-how in the work. However, there exists no user support server for providing information such as “what undesirable results occur in a case where know-how in work is not used” and “the reason why the undesirable results occur”.

### SUMMARY OF THE INVENTION

An object of the present invention is to provide, in a knowledge providing apparatus that provides, with respect to knowledge for supporting predetermined work performed by a user, the contents thereof corresponding to the level of skill of the user, a knowledge providing apparatus capable of judging the level of skill of the user again to automatically update the level of skill of the user every time the work is performed by the user.

Another object of the present invention is to provide a knowledge providing apparatus that can also provide the procedure for work, the contents of the work, and know-how in the work as well as information such as “what undesirable results occur in a case where the know-how in work is not used” and “the reason why the undesirable results occur”.

In a knowledge providing apparatus that is connected to a user terminal and provides, with respect to knowledge for supporting predetermined work performed by a user, the contents thereof corresponding to the level of skill of the user to the user terminal, and can provide knowledge of a particular type on the basis of a keyword retrieval operation, a first knowledge providing apparatus according to the present invention is characterized by comprising a user information database storing for each user the current level of skill in the work of the user and information related to the history of the work performed by the user; and means for judging, when the predetermined work performed by an arbitrary user is terminated, the level of skill of the user again to update the current level of skill of the user in the user information database on the basis of the complexity of the contents of the work, information related to the evaluation of the results of the work, the number of times of keyword retrieval performed by the user during the work, the current level of skill of the user, and information related to the history of the work performed in the past by the user. The predetermined work performed by the user may be work performed by the user utilizing the user terminal (work performed on the user terminal) or may be work performed by the user without utilizing the user terminal.

In a knowledge providing apparatus that is connected to a user terminal and provides to the user terminal knowledge for supporting predetermined work performed by a user, a second knowledge providing apparatus according to the present invention is characterized by comprising a knowledge database storing knowledge for supporting the work performed by the user; and means for reading out required information from the knowledge database on the basis of access from the user terminal, generating display data on the basis of the read knowledge, and transmitting the generated display data to the user terminal, the knowledge database storing for each work item in a predetermined unit the name of work, the contents of the work, and know-how in the work as well as undesirable results in a case where the know-how in the work is not used and the reason why the undesirable results occur. The predetermined work performed by the user may be work performed by the user utilizing the user terminal (work performed on the user terminal) or may be work performed by the user without utilizing the user terminal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a three-dimensional object generating system;

FIG. 2 is a schematic view showing an example of a part of the contents of a knowledge database 42;

FIG. 3 is a flow chart showing the overall procedure for generating a three-dimensional object;

FIG. 4 is a flow chart showing the procedure for generating plotter data for molding a three-dimensional object in the step 2 shown in FIG. 3;

FIG. 5 is a flow chart showing the procedure for remotely operating a laser stereolithography device 21 in the step 4 shown in FIG. 3;

FIG. 6 is a flow chart showing the procedure for user authentication processing;

FIG. 7 is a schematic view showing an example of a user authentication screen;

FIG. 8 is a schematic view showing an example of a basic screen;

FIG. 9 is a flow chart showing the procedure for manual reading processing;

FIG. 10 is a schematic view showing an example of a manual display screen corresponding to an elementary level (a level 1);

FIG. 11 is a schematic view showing an example of a manual display screen corresponding to an advanced level (a level 3)

FIG. 12 is a flow chart showing the procedure for retrieving know-how and a failure case;

FIG. 13 is a schematic view showing an example of a result list display screen in a case where know-how retrieval is selected as the type of retrieval:

FIG. 14 is a schematic view showing an example of a know-how and failure case details display screen in a case where know-how retrieval is selected as the type of retrieval;

FIG. 15 a schematic view showing an example of a result list display screen in a case where failure case retrieval is selected as the type of retrieval;

FIG. 16 is a schematic view showing an example of a know-how and failure case details display screen in a case where failure case retrieval is selected as the type of retrieval; and

FIG. 17 is a flow chart showing the procedure for updating a user level.

### DESCRIPTION OF THE PREFERRED EMBODIMENTS

Referring now to the drawings, description is made of an embodiment in a case where the present invention is applied to a three-dimensional object generating system.

### [1] Description of Configuration of Three-dimensional Object Generating System

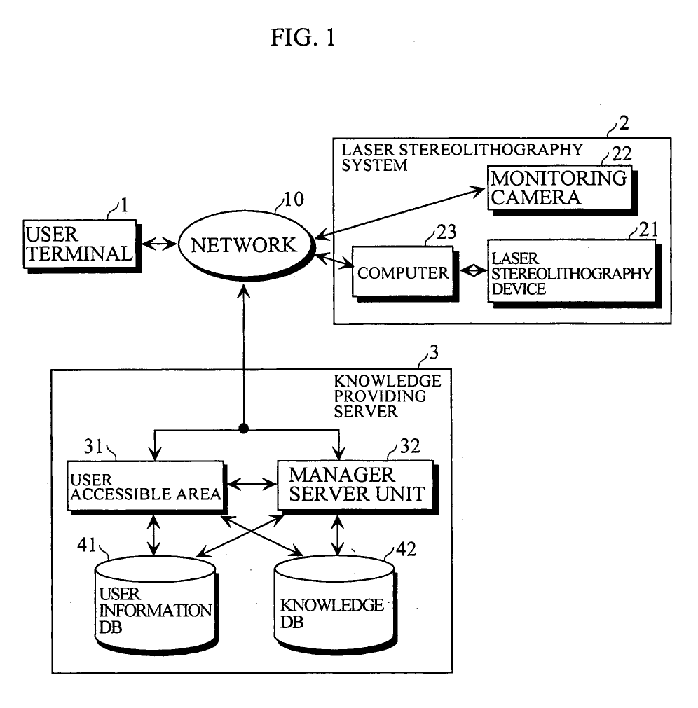

FIG. 1 illustrates the configuration of a three-dimensional-object generating system.

The three-dimensional object generating system comprises a user terminal 1 connected to a network 10 such as the Internet, a laser stereolithography system 2 connected to the network 10, and a user support server (a knowledge providing apparatus, a knowledge providing server) 3 connected to the network 10. Although a plurality of user terminals 1 actually exist, only one user terminal 1 is illustrated in FIG. 1.

The laser stereolithography system 2 comprises a laser stereolithography device 21, a monitoring camera 22 for imaging the operating conditions of the laser stereolithography device 21, and a computer for controlling a laser stereolithography device (hereinafter referred to as a laser stereolithography device controlling computer) 23. The laser stereolithography device 21 performs such an operation as to irradiate liquid ultraviolet curing resin with a laser beam to cure the ultraviolet curing resin is performed over a plurality of layers, thereby generating a three-dimensional object.

The laser stereolithography device 21 is connected to the laser stereolithography device controlling computer 23. Further, the laser stereolithography device controlling computer 23 may, in some cases, be incorporated in the main body of the laser stereolithography device 21. Laser stereolithography device controlling software for controlling the laser stereolithography device 21, for example, is installed in the laser stereolithography device controlling computer 23. Further, the laser stereolithography device controlling computer 23 comprises the function of communicating with the user terminal 1 through the network 10, and comprises a browser or dedicated software for accessing a server unit for a manager (hereinafter referred to as a manager server unit) 32 in the knowledge providing server 3.

The monitoring camera 22 is connected to the network 10. The monitoring camera 22 comprises a zooming function and the function of changing the direction of monitoring. The monitoring camera 22 may be connected to the network 10 through the laser stereolithography device controlling computer 23. A connecting method may be either wire connection or radio connection.

Furthermore, the monitoring camera 22 has an automatic focusing function in addition to the function of memorizing several places which are frequently seen by a user, and can automatically correct its focus. In the case of a three-dimensional plotter, in which a molded object sinks in a liquid, such as a laser stereolithography device, the monitoring camera 22 may not, in some cases, be focused on an area which the user desires to confirm only by automatic focusing. In the case, the monitoring camera has a control menu for also allowing manual focusing.

Installed in the user terminal 1 are 3D data generating software for generating three-dimensional data (3D data) representing a three-dimensional object, plotter data generating software (hereinafter referred to as plotter data editor) for generating data for a laser stereolithography device (hereinafter referred to as plotter data) from the 3D data representing the three-dimensional object, remote operation software for remotely operating the laser stereolithography device 21 by remotely operating the laser stereolithography device controlling software in the laser stereolithography device controlling computer 23 on the side of the laser stereolithography system 2, remote monitoring software for monitoring the operating conditions of the laser stereolithography device 21 by receiving and displaying a video from the monitoring camera 22 on the side of the laser stereolithography system 2 as well as remotely operating the monitoring camera 22 (performing remote operations such as zooming and change in the monitoring position), and so forth.

That is, the user terminal 1 comprises functions such as a 3D data generation function for generating the 3D data representing the three-dimensional object, a plotter data generation function for generating the plotter data from the 3D data representing the three-dimensional object, a remote operation function for remotely operating the laser stereolithography device 21, and a monitoring function for monitoring the operating conditions of the laser stereolithography device 21. Further, the user terminal 1 comprises a browser or dedicated software for accessing a server unit for a user (hereinafter referred to as a user accessible area) 31 in the knowledge providing server 3.

The knowledge providing server 3 comprises the user accessible area 31, the manager server unit 32, a user information database 41 for judging the level of a user, and a knowledge database 42 for storing knowledge provided in order to support work performed by the user. The user accessible area 31 provides to each of the user terminals 1 knowledge for supporting work performed by the user (in this example, work for generating the plotter data, work for remotely operating the laser stereolithography device 21, and post-processing work for a molded object) as a Web page or display on a screen using dedicated software. That is, an electronic manual including the procedure for work is provided, and know-how, a failure case, etc. are provided when the user retrieves the know-how and the failure case. In this case, the contents of display are changed depending on the level of skill of the user (hereinafter referred to as a user level).

The manager server unit 32 provides a Web page for acquiring information from a manager on the side of the laser stereolithography system 2. The manager server unit 32 feeds information obtained from the manager to the user information database 41 and the knowledge database 42.

The user information database 41 stores for each user ID a password previously registered by a user having the user ID, information representing the current user level of the user, and history information related to the user. The user level is judged on the basis of the complexity of the contents of work performed by the user, information related to the evaluation of the results of the work, the number of times of retrieval performed during the work, etc., as described later. The history information includes the complexity of the contents of work performed in the past by the user, information related to the evaluation of the results of the work, the number of times of retrieval performed during the work, etc. The complexity of the contents of the work performed by the user and the information related to the evaluation of the results of the work are fed to the manager server unit 32 through the laser stereolithography device controlling computer 23 and the network 10 from the manager on the side of the laser stereolithography system 2.

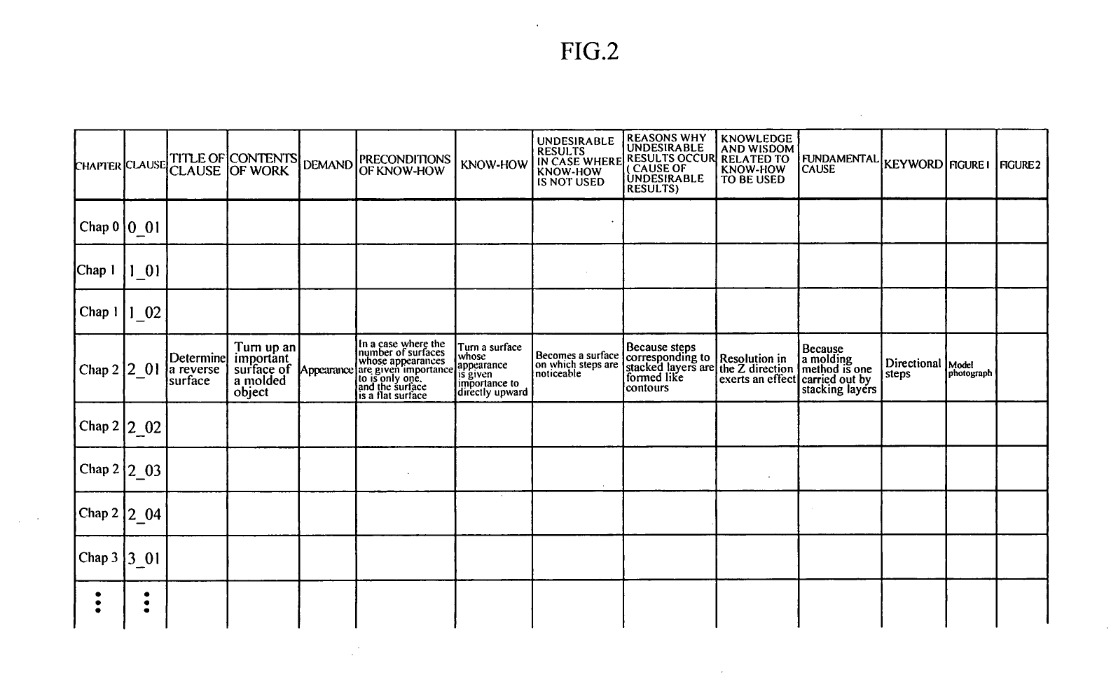

The knowledge database 42 stores, in each of work items in clause units specified by a “chapter” and a “clause”, “the title of a clause (the name of work)”, “the contents of work”, a “demand”, “preconditions of know-how”, “know-how”, “undesirable results in a case where no know-how is used”, “the reason why undesirable results occur (the cause of undesirable results)”, “knowledge and wisdom related to know-how to be used”, a “fundamental cause”, a “keyword”, a “FIG. 1 (a reference image 1)”, a “FIG. 2 (a reference image 2)”, etc., as shown in FIG. 2. Although in FIG. 2, only knowledge corresponding to the work item in Clause 1 of Chapter 2 (2-01) are illustrated, knowledge also actually exist in the other work items in clause units.

### [2] Description of Overall Procedure for Generating Three-dimensional Object

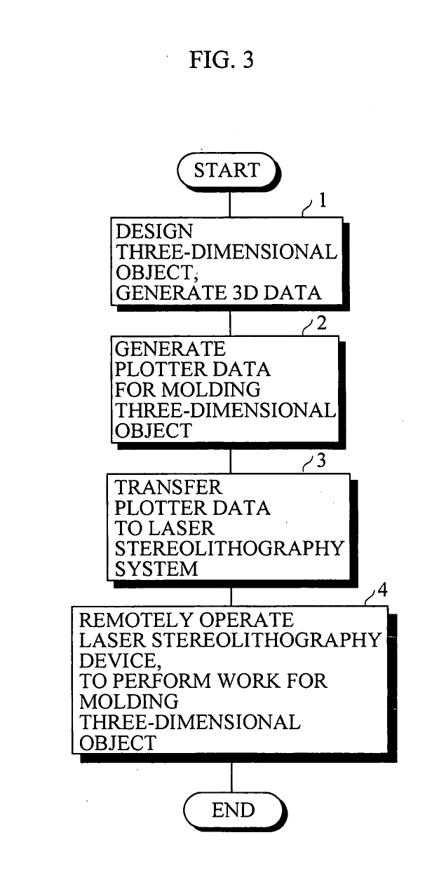

FIG. 3 shows the overall procedure for generating a three-dimensional object.

First, a three-dimensional object, for example, a casing of a portable telephone set is designed utilizing a 3D data generation function of the user terminal 1 (step 1). That is, 3D data (STL (Stereo Lithography) data) representing the three-dimensional object is generated.

Data representing a cross section for molding a three-dimensional object (hereinafter referred to as three-dimensional object molding cross section data) and support data are then generated from the 3D data (STL data) representing the three-dimensional object utilizing a plotter data generation function of the user terminal 1 (step 2). That is, plotter data for molding a three-dimensional object is generated. In this case, the user accesses the user accessible area 31 in the knowledge providing server 3 from the user terminal 1 to acquire the Web page for supporting plotter data generation work, thereby making it possible to utilize the knowledge provided by the knowledge providing server 3. A support is a member for supporting, at the time of molding a three-dimensional object, the three-dimensional object, and generated integrally with the three-dimensional object at the time of molding the three-dimensional object and removed after the completion.

The generated plotter data is then transferred to the laser stereolithography device controlling computer 23 on the side of the laser stereolithography system 2 (step 3).

Thereafter, the laser stereolithography device 21 on the side of the laser stereolithography system 2 is remotely operated utilizing the remote operation function and the monitoring function of the user terminal 1, to perform work for molding the three-dimensional object (step 4). In this case, the user accesses the user accessible area 31 in the knowledge providing server 3 from the user terminal 1, to acquire a Web page for supporting the work for remotely operating the laser stereolithography device 21, thereby making it possible to utilize the knowledge provided by the knowledge providing server 3.

When a three-dimensional object. (a molded object) is generated by the three-dimensional object molding work, post-processing work for the obtained molded object is performed. The post-processing work may be performed by the manager on the side of the laser stereolithography system 2, or may be performed by the user going off to the place where the laser stereolithography system 2 is installed. Examples of the post-processing work for the molded object include a washing step, a secondary curing step, a support removal step, and a surface treatment step of the molded object in this order. The secondary curing step, the support removal step, and the surface treatment step may not, in some cases, be required depending on the type of resin and a molding shape. Further, the secondary curing step and the support removal step may, in some cases, be carried out in the reverse order.

When the user goes off to the place where the laser stereolithography system 2 is installed to perform the post-processing work, a computer put in the place where the laser stereolithography system 2 is installed and a computer (a portable computer) carried by the user are connected to the network to access the knowledge providing server 3, to acquire a Web page for supporting the post-processing work for the molded object, thereby making it possible utilize the knowledge provided by the knowledge providing server 3.

### [3] Description of Procedure for Generating Plotter Data for Molding Three-dimensional Object in Step 2 Shown in FIG. 3

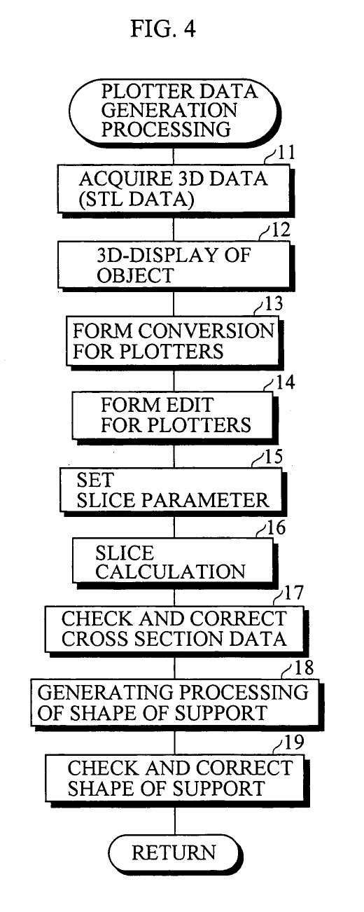

FIG. 4 shows the procedure for generating plotter data for molding a three-dimensional object in the step 2 shown in FIG. 3.

The 3D data (STL data) representing the thee-dimensional object generated in the step 1 is first acquired (step 11). The three-dimensional object is 3D-displayed on the basis of the acquired STL data (step 12). The STL data is then converted into data representing a shape for a plotter corresponding to a format for a laser stereolithography device (step 13). The shape for a plotter is edited (step 14). That is, the direction of slicing (the direction of molding) is determined by rotating a display image.

After a slice parameter such as a slice pitch is set (step 15), slice calculation is carried out (step 16). That is, the 3D data is sliced, to generate molding cross section data. The obtained molding cross section data is checked and corrected (step 17).

Processing for generating a support is then performed (step 18). The shape of the obtained support is checked and corrected (step 19).

### [4] Description of Procedure for Remotely Operating Laser Stereolithography Device 21 in Step 4 Shown in FIG. 3

FIG. 5 shows the procedure for remotely operating the laser stereolithography device 21 in the step 4 shown in FIG. 3.

First, processing for setting a molding parameter is performed (step 21). That is, a molding size, molding arrangement, exposure to light, a laser scanning pattern, coating, etc. are set.

Molding work is then performed, thereby generating a three-dimensional object (molded object) (step 22).

### [5] Description of Processing Performed between User Terminal 1 and Knowledge Providing Sever 3

Examples of processing performed between the user terminal 1 and the knowledge providing server 3 include user authentication processing, manual reading processing, and know-how and failure case retrieval processing. Further, the knowledge providing server 3 performs, after the work performed by the user is terminated, processing for updating the knowledge level of the user (user level). The processing will be hereinafter described.

### [5.1] User Authentication Processing

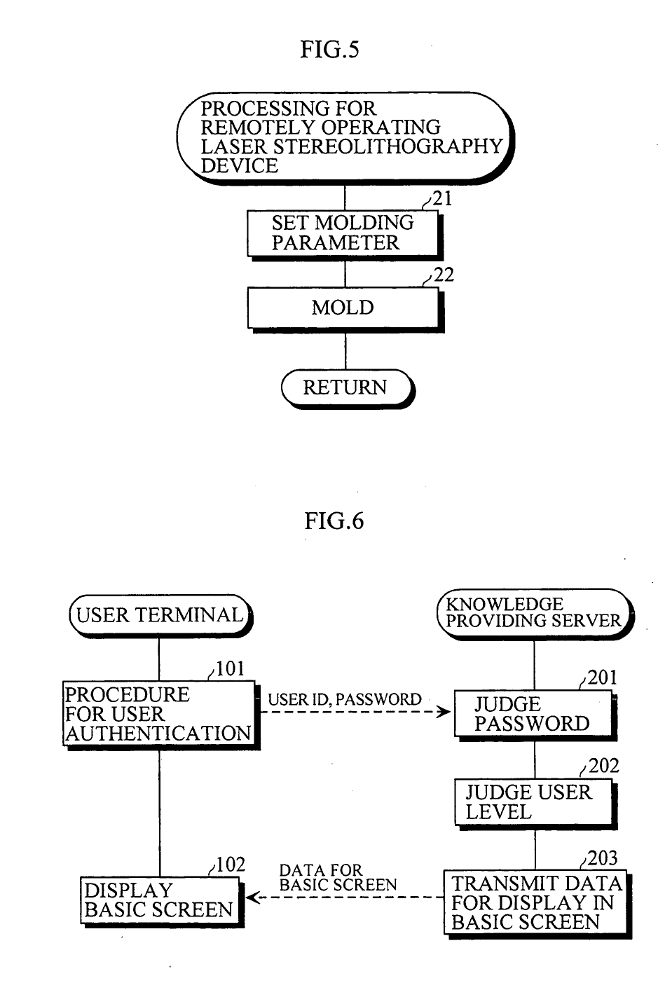

FIG. 6 shows the procedure for user authentication processing.

A user operates the user terminal 1, to carry out the procedure for user authentication (step 101).

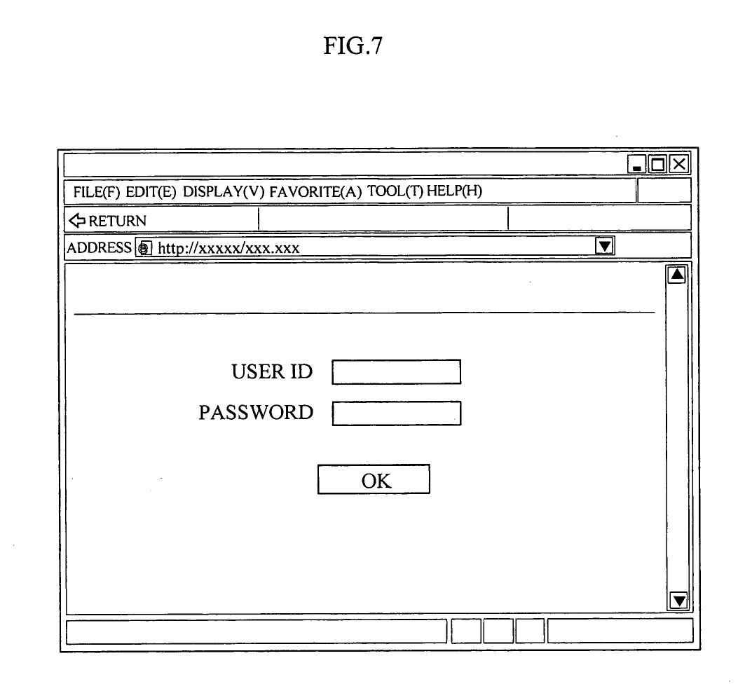

That is, when the user accessible area 31 in the knowledge providing server 3 (hereinafter referred to as the knowledge providing server 3) is accessed from the user terminal 1, a user authentication screen as shown in FIG. 7 is provided to the user terminal 1 from the knowledge providing server 3, and is displayed on the user terminal 1. When the user clicks an OK button after entering a user ID and a password which are previously registered in the user accessible area 31 on the user authentication screen, the entered user ID and password are sent to the knowledge providing server 3.

The knowledge providing server 3 judges whether or not the password is correct on the basis of the password and the user ID sent from the user terminal 1 (step 201). The judgment is made by referring to the user information database 41. Further, the knowledge providing server 3 judges, when the password is correct, the user level by referring to the user information database 41 and holds the results of the judgment (step 202), and transmits data for displaying a basic screen to the user terminal 1 (step 203).

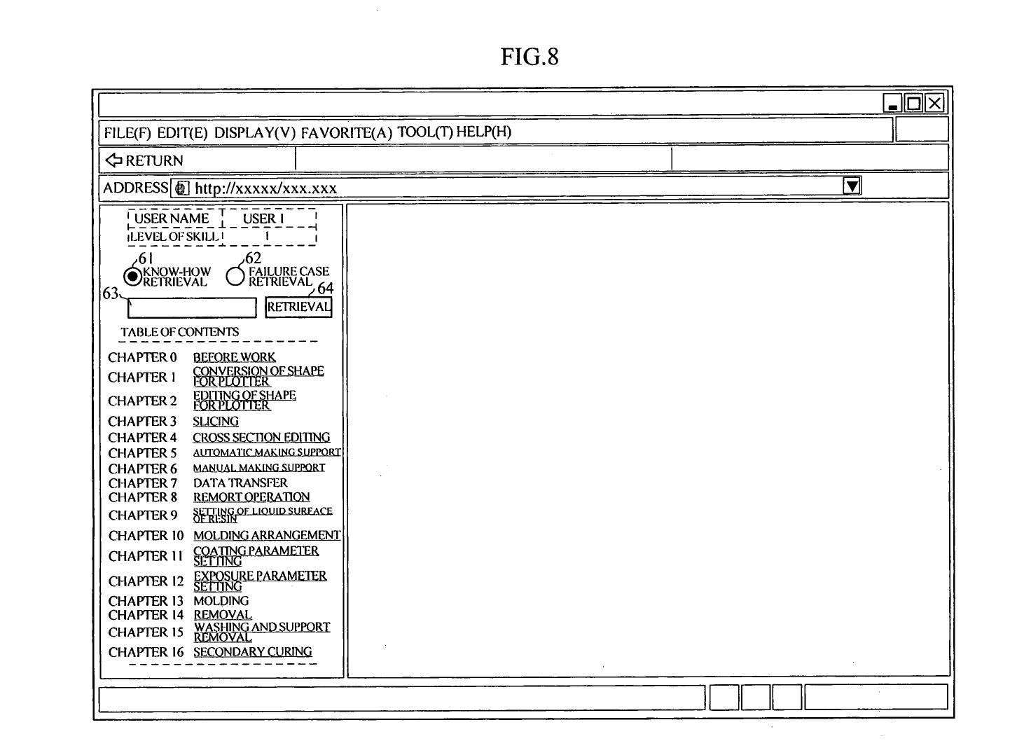

When the user terminal 1 receives the data for a basic screen, the basic screen as shown in FIG. 8 is displayed on the user terminal 1 (step 102). The basic screen is constituted by a user operating display portion on the left side and a manual display portion on the right side.

User information, an operation portion for know-how and failure case retrieval, and a table of contents for manual reading are displayed on the user operating display portion. As the user information, the name and the level (the level of skill) of the user are displayed. The user levels are of three types, i.e., an elementary level (level 1), an intermediate level (level 2), and an advanced level (level 3) in the present embodiment. Here, the user level (the level of skill) is an index indicating how the user acquires knowledge for performing the work.

On the operation portion for know-how and failure case retrieval, radio buttons 61 and 62 for selecting either know-how retrieval or failure case retrieval, a retrieval word entry part 63, and a retrieval execution button 64 are displayed. On the table of contents for manual reading, work names respectively corresponding to Chapter 0 to Chapter 16 (work names in chapter units) are displayed as hyperlink's. anchors in this example.

### [5.2] Manual Reading Processing

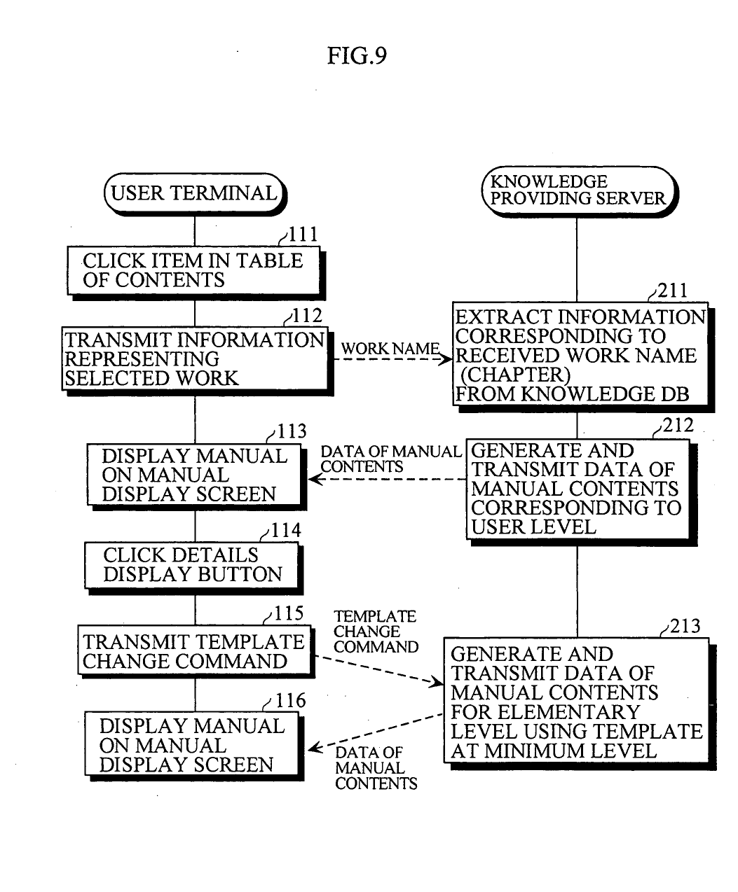

FIG. 9 shows the procedure for manual reading processing.

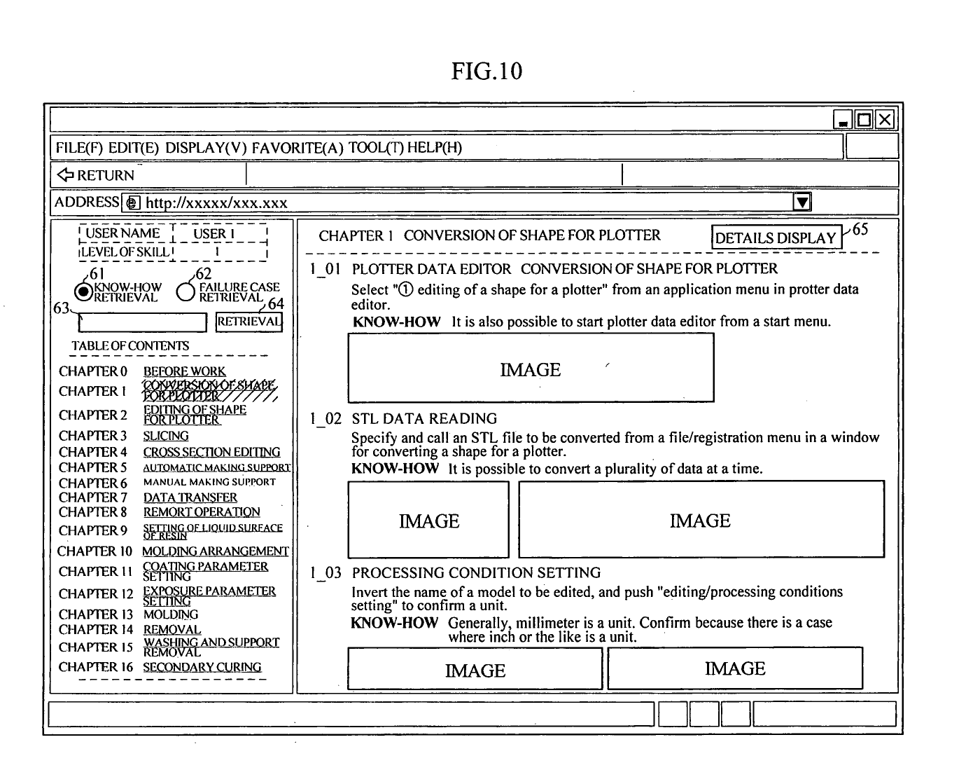

When the user clicks an item in the table of contents (the work name in the chapter unit) on the basic screen or a manual display screen (see FIG. 10) (step 111), information representing the clicked work name (chapter) is transmitted to the knowledge providing server 3 (step 112).

The knowledge providing server 3 extracts information corresponding to the received work name (chapter) from the knowledge database 42 (step 211). Data for displaying a manual corresponding to the user level of the user is generated on the basis of a template corresponding to the user level of the user and the information extracted in the step 211, and is transmitted to the user terminal 1 (step 212).

The user terminal 1 displays, when it receives the data of manual contents, the manual display screen, as shown in FIG. 10, for example, on the basis of the received data (step 113). In the manual display screen, a manual is displayed on the manual display portion in the basic screen shown in FIG. 8. In the example shown in FIG. 10, the user level of the user is the elementary level (level 1), so that a detailed manual is displayed. That is, the procedure for work is shown, and know-how and an image are displayed if they exist in the database for each procedure for work.

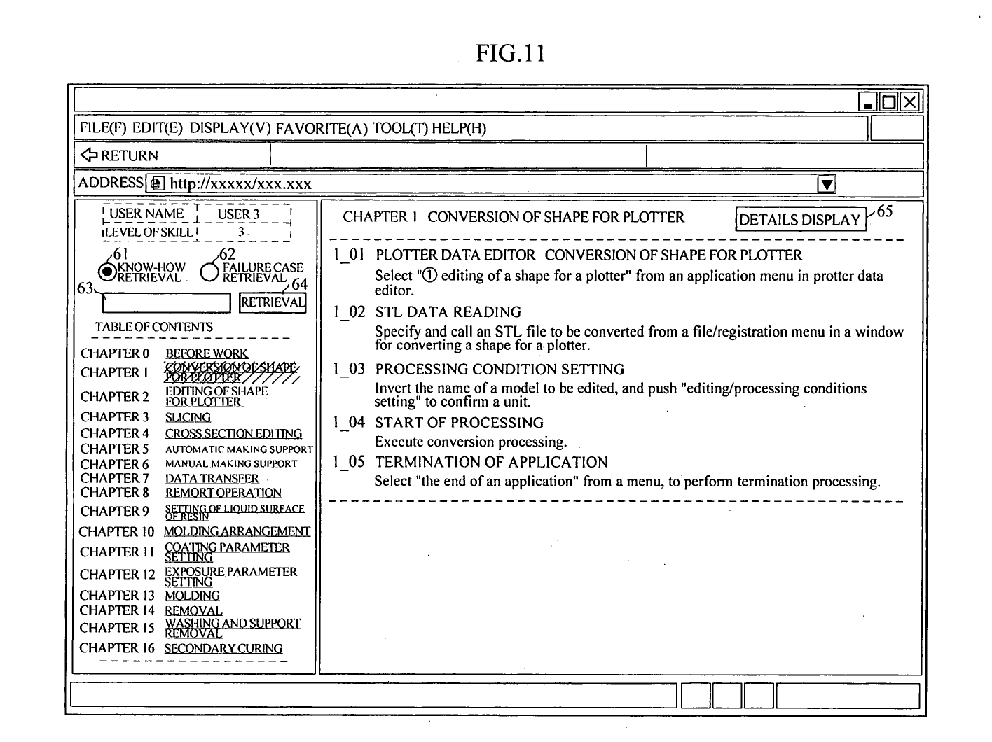

FIG. 11 shows a manual display screen corresponding to the advanced level (level 3). In the example shown in FIG. 11, the user level is the advanced level, whereby only the procedure for work is shown.

The user sees a manual displayed on the manual display screen, and clicks, when he or she cannot understand the manual, a details display button 65 (see FIGS. 10 and 11) on the manual display screen. When the details display button 65 is clicked (step 114), a template change command is transmitted to the knowledge providing server 3 (step 115).

The knowledge providing server 3 generates, when it receives the template change command, data for an elementary level manual using a template at the minimum level (elementary level), and transmits the generated data to the user terminal 1 (step 213). The user terminal 1 displays, when it receives the data of manual contents, a manual display screen on the basis of the received data (step 116).

### [5.3] Processing for Retrieving Know-how and Failure Case

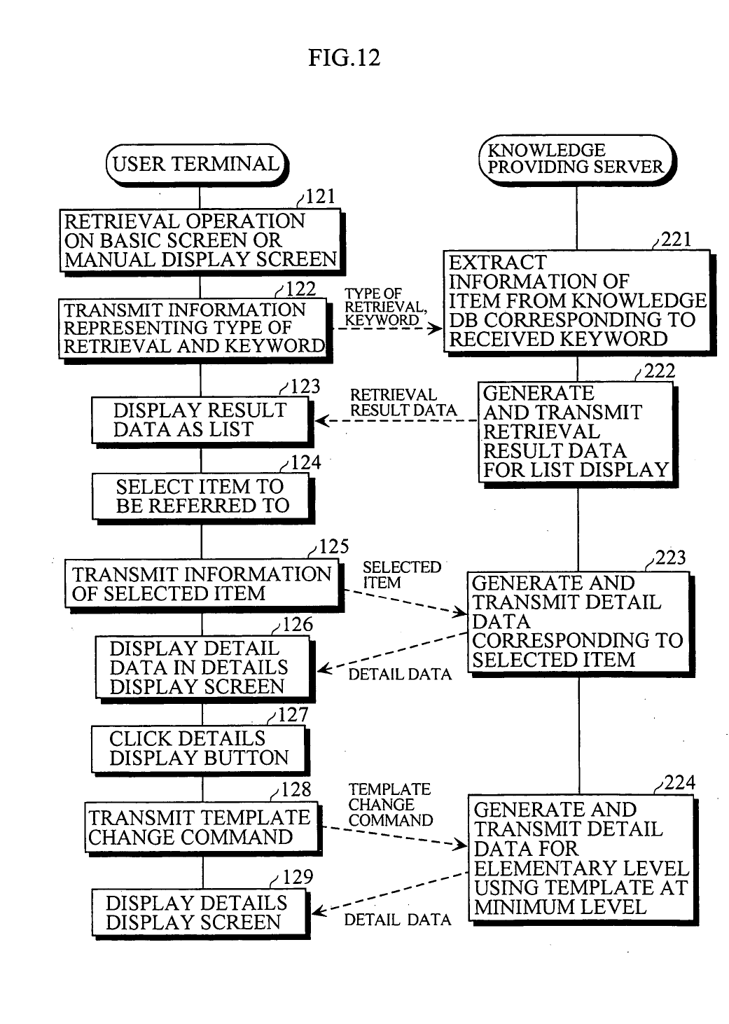

FIG. 12 shows the procedure for retrieving know-how and a failure case.

When the user performs a retrieval operation on the basic screen or the manual display screen, that is, designates the type of retrieval (know-how retrieval or failure case retrieval) using the radio buttons 61 and 62, enters a word to be retrieved (a keyword) into the retrieval word entry part 63, and then clicks the retrieval execution button 64 (step 121), the selected type of retrieval and information related to the entered keyword are transmitted to the knowledge providing server 3 (step 122).

The knowledge providing server 3 extracts information of an item (an item in a clause unit) corresponding to the received keyword, from the knowledge database 42 (step 221). Data for displaying a list of retrieval results is generated on the basis of the received type of retrieval and the information extracted in the step 221, and is transmitted to the user terminal 1 (step 222).

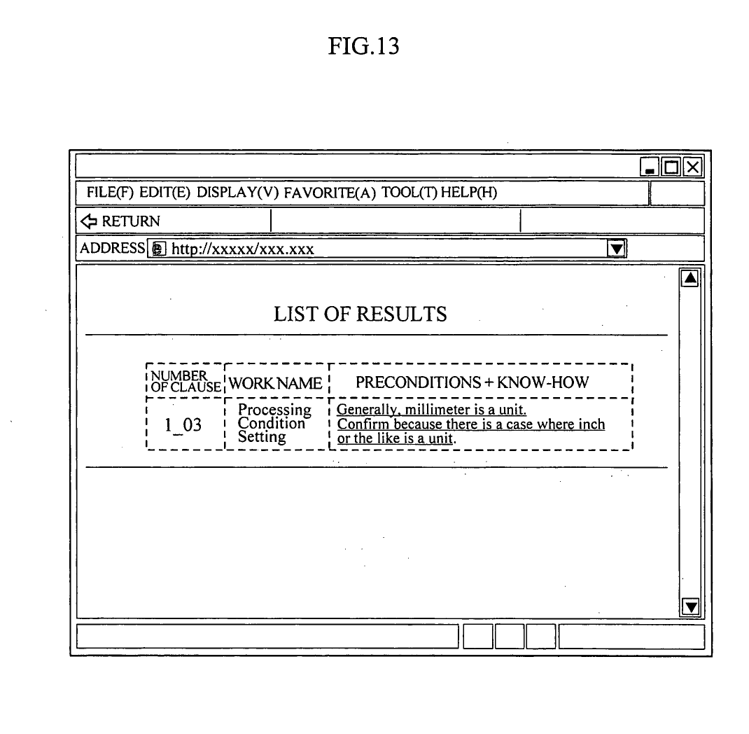

The user terminal 1 displays, when it receives the retrieval result data for list display, a result list display screen as shown in FIG. 13, for example, on the basic screen or a window different from the manual display screen on the basis of the received retrieval result data (step 123). FIG. 13 illustrates an example of the result list display screen in a case where the know-how retrieval is selected as the type of retrieval. In this example, an example in a case where only one item is retrieved is illustrated. Displayed on the result list display screen are, for each retrieved item (item in a clause unit), the number of a clause, the title of the clause (the name of work), preconditions, and know-how. In order to cause the user to select the item to be referred to, a character string representing preconditions and the contents of know-how is displayed as a hyperlink's anchor.

The user selects the item to be referred to out of the items displayed on the result list display screen. The item to be referred to is selected by clicking the anchor corresponding to the item to be referred to on the result list display screen.

When the item to be referred to is selected on the result list display screen (step 124), information of the selected item is transmitted to the knowledge providing server 3 (step 125). The knowledge providing server 3 generates, on the basis of the type of retrieval selected by the user, the template corresponding to the user level of the user, the information extracted in the step 221, and the item selected by the user, data for displaying the details of know-how and a failure case corresponding to the selected item, and transmits the generated detail data to the user terminal 1 (step 223).

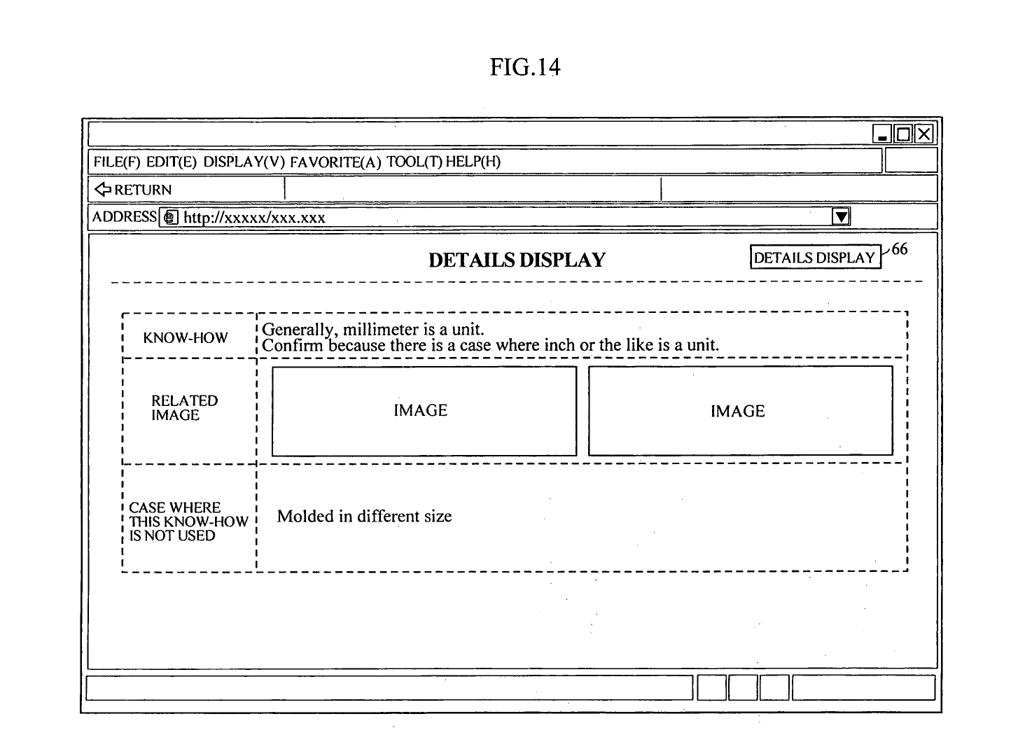

The user terminal 1 displays, when it receives the detail data, a know-how and failure case details display screen, as shown in FIG. 14, for example, on the basis of the received data (step 126). In an example shown in FIG. 14, the contents of know-how, a related image, and description in a case where the know-how is not used are displayed.

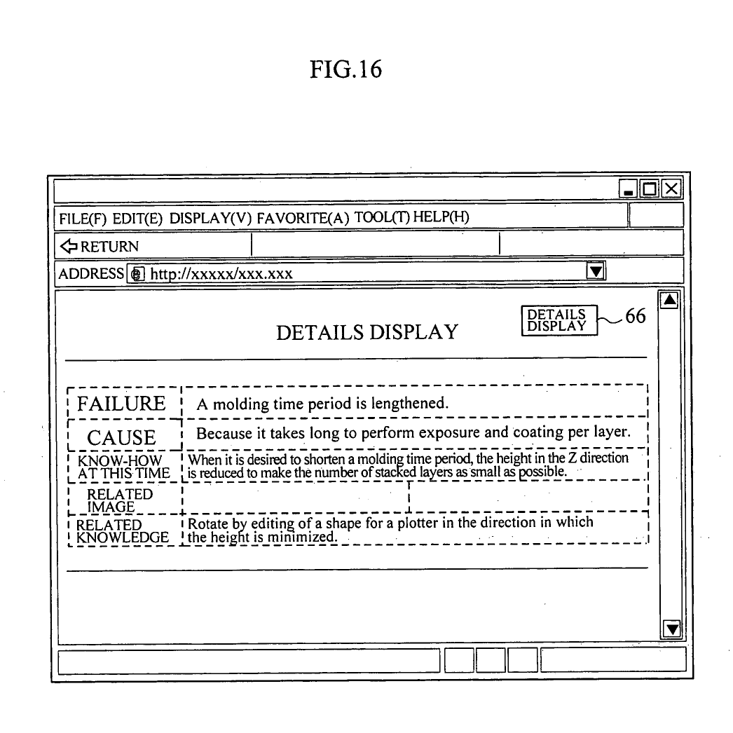

The user sees contents displayed on the know-how and failure case details display screen, and clicks, when he or she cannot understand the contents, a details display button 66 (see FIGS. 14 and 16) on the know-how and failure case details display screen. When the details display button 66 is clicked (step 127), the template change command is transmitted to the knowledge providing server 3 (step 128).

The knowledge providing server 3 generates, when it receives the template change command, detail data for the elementary level using the template at the lowest level (the elementary level), and transmits the generated detail data to the user terminal 1 (step 224). The user terminal 1 displays, when it receives the detail data, the know-how and failure case details display screen on the basis of the received data (step 129).

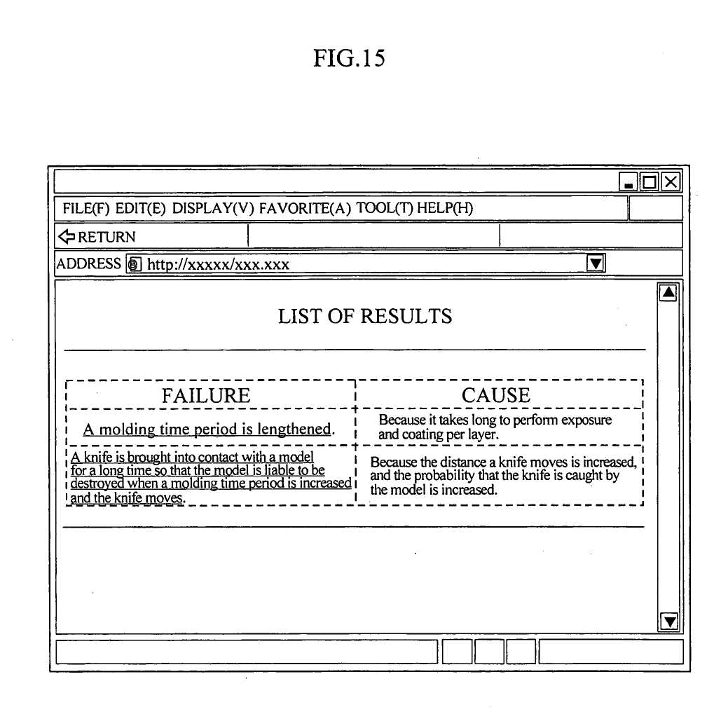

An example of the result list display screen at the time of failure case retrieval and an example of the know-how and failure case details display screen at the time of failure case retrieval are respectively illustrated in FIGS. 15 and 16.

### [5.4] Processing for Updating User Level

When the work performed by the user is terminated, and the three-dimensional object is generated on the side of the laser stereolithography system 2, the manager on the side of the laser stereolithography system 2 judges the level of complexity of the contents of the current work and evaluates the results of the current work (the workmanship of the molded object).

The level of complexity of the contents of work means complexity (difficulty) in performing the work, that is, an index of a viewpoint as to how complex (or difficult) an object or a state outputted by the work is and how complex (how difficult) the steps of the work are, and is determined by items such as the number of faces, the presence or absence of an overhang shape, the number of holes, the size, the number of special shapes, and the requirement precision of a molded object in laser stereolithography.

An example of a method of judging the level of complexity of the contents of work include a method of the manager on the side of the laser stereolithography system 2 confirming and judging the level of complexity in advance (before the work) on the basis of the criteria of the items, or a method of automatically judging the level of complexity on the basis of the criteria for the judgment previously defined on the basis of the items. For convenience of illustration, as the level of complexity of the work, three types of levels, i.e., Level 1, Level 2, and Level 3 previously defined on the basis of the foregoing items are herein set. The complexity is the highest at the level 3, while being the lowest at the level 1.

The evaluation of the results of work (the workmanship of a molded object) means evaluation obtained by comparing the results of work performed utilizing the knowledge providing server 3 with an object or a state, etc. which should be completed by utilizing the initial target of the work and the knowledge provided by the knowledge providing server 3. A plurality of evaluation levels conforming to the contents of the work can be set. Here, the generated molded object shall be evaluated at two types of evaluation levels, i.e., good (success) and bad (failure).

An example of the evaluating method is evaluation by the subjectivity of the manager on the side of the laser stereolithography system 2, evaluation by comparison with a reference object, or evaluation using a measuring device.

The manager on the side of the laser stereolithography system 2 accesses the manager server unit 32 in the knowledge providing server 3, to notify the knowledge providing server 3 of the ID of a user who has performed the current work, the level of complexity of the contents of the current work, and the results of the evaluation of the workmanship of the results of the current work (the molded object).

The knowledge providing server 3 performs processing for updating the user level on the basis of the level of complexity of the contents of the work, the results of the evaluation of the workmanship of the results of the work (the molded object), the number of times of know-how and failure case retrieval by the user in the current work, the current user level of the user who has performed the current work, and the number of previous successful experiences of the user which are sent from the manager on the side of the laser stereolithography system 2.

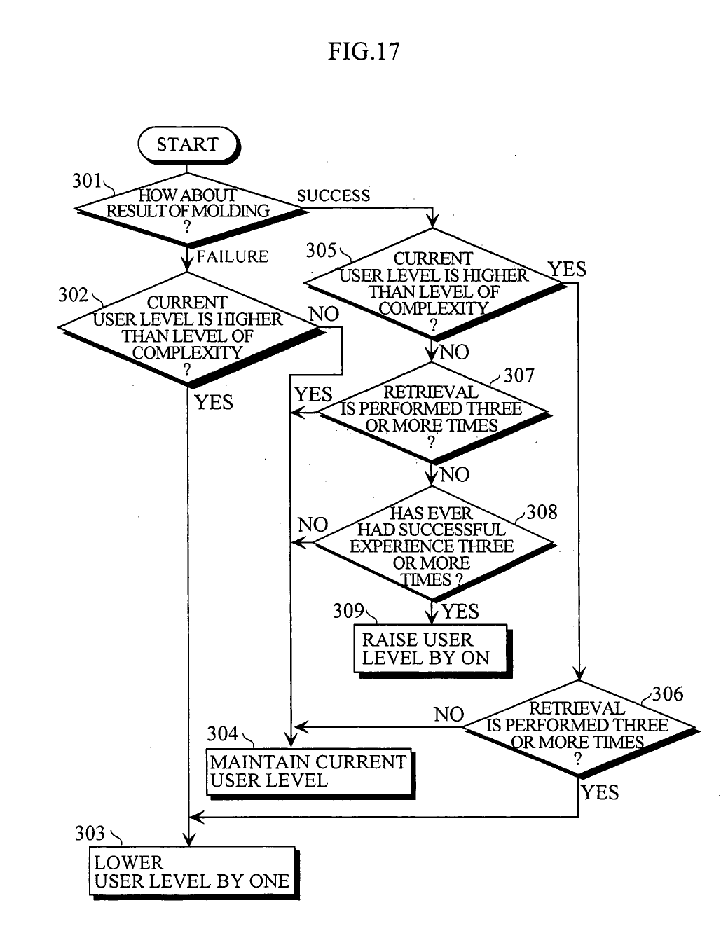

FIG. 17 shows the procedure for updating the user level.

First, the result of the evaluation of the workmanship of the molded object is judged (step 301). When the result of the evaluation of the workmanship is “failure”, the current user level and the level of complexity are compared with each other (step 302). When the current user level is higher than the level of complexity, the user level is lowered by one (step 303). When the current user level is not more than the level of complexity, the current user level is maintained (step 304).

When it is judged in the foregoing step 301 that the result of the evaluation of the workmanship is “success”, the current user level and the level of complexity are compared with each other (step 305). When the current user level is higher than the level of complexity, it is judged whether or not the know-how and failure case retrieval is performed three or more times (step 306). If the know-how and failure case retrieval is performed three or more times, the user level is lowered by one (step 303). Unless the know-how and failure case retrieval is performed three or more times, the current user level is maintained (step 304).

When it is judged in the foregoing step 305 that the current user level is not more than the level of complexity, it is judged whether or not the know-how and failure case retrieval is performed three or more times (step 307). If the know-how and failure case retrieval is performed three or more times, the current user level is maintained (step 304). Unless the know-how and failure case retrieval is performed three or more times, it is judged whether or not the user has ever had successful experiences three or more times (step 308).

If the user has ever had successful experiences three or more times, the user level is raised by one (step 309). Unless the user has ever had successful experiences three or more times, the current user level is maintained (step 304)

In a case where the user level is lowered by one in the foregoing step 303 or a case where the user level is raised by one in the foregoing step 309, the user level corresponding to the user in the user information database 41 is updated.

The present invention is also applicable to a case where work other than the work described in the foregoing embodiment (the work for generating the three-dimensional object) is performed utilizing the user terminal 1. Further, the present invention is also applicable to work performed without utilizing the user terminal 1.

Although the present invention has been described and illustrated in detail, it is clearly understood that the same is by way of illustration and example only and is not to be taken by way of limitation, the spirit and scope of the present invention being limited only by the terms of the appended claims.

What is claimed

1. In a knowledge providing apparatus that is connected to a user terminal and provides, with respect to knowledge for supporting predetermined work performed by a user, the contents thereof corresponding to the level of skill of the user to the user terminal, and can provide knowledge of a particular type on the basis of a keyword retrieval operation, a knowledge providing apparatus characterized by comprising:
a user information database storing for each user the current level of skill in said work of the user and information related to the history of the work performed by the user; and
means for judging, when said predetermined work performed by an arbitrary user is terminated, the level of skill of the user again to update the current level of skill of the user in the user information database on the basis of the complexity of the contents of the work, information related to the evaluation of the results of the work, the number of times of keyword retrieval performed by the user during the work, the current level of skill of the user, and information related to the history of the work performed in the past by the user.

2. In a knowledge providing apparatus that is connected to a user terminal and provides to the user terminal knowledge for supporting predetermined work performed by a user,
a knowledge providing apparatus characterized by comprising:
a knowledge database storing knowledge for supporting said work performed by the user; and
means for reading out required information from the knowledge database on the basis of access from the user terminal, generating display data on the basis of the read knowledge, and transmitting the generated display data to the user terminal,
the knowledge database storing for each work item in a predetermined unit the name of work, the contents of the work, and know-how in the-work as well as undesirable results in a case where the know-how in the work is not used and the reason why the undesirable results occur.
